(19) United States
(12) Patent Application Publication
(10) Pub. No.: US 2021/0283435 A1
(43) Pub. Date: Sep. 16, 2021

(54) Respirator Including Reinforcing Element

(71) Applicant: 3M INNOVATIVE PROPERTIES COMPANY, St. Paul, MN (US)

(72) Inventors: Dong-Sun Noh, Gunpo-si (KR); SangHoon Lee, Hwaseong-si (KR); Kangsoo Park, Osan-si (KR)

(21) Appl. No.: 16/344,841

(22) PCT Filed: Oct. 25, 2017
(86) PCT No.: PCT/US2017/058227

§ 371 Date: Apr. 25, 2019

Related U.S. Application Data
(60) Provisional application No. 62/414,036, filed on Oct. 28, 2016.

(51) Int. Cl. A62B 23/02; A41D 13/11

(52) U.S. Cl. CPC A62B 23/025; A41D 2500/30; A41D 13/113

(57) ABSTRACT

Various embodiments of a filtering face-piece respirator are disclosed. The respirator can include a mask body that includes a collapsible zone disposed along at least a portion of a perimeter of the mask body and a reinforcing element disposed in an upper region of the mask body to define a reinforced zone of the mask body. The reinforced zone is at least partially surrounded by the collapsible zone.

### BACKGROUND

Respirators are commonly worn over a person's breathing passages in at least one of two situations: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that may be harmful to the wearer, for example, in an auto body shop. In the second situation, the respirator is worn in an environment where there is risk of contamination to other persons or things, for example, in an operating room or clean room.

A variety of respirators have been designed to be used in one or both of these situations. Some of these respirators have been categorized as being “filtering face-pieces” because the mask body itself functions as the filtering mechanism. Unlike respirators that use rubber or elastomeric mask bodies with attachable filter cartridges (see, e.g., U.S. Pat. No. RE39,493 to Yuschak et al.) or insert-molded filter elements (see, e.g., U.S. Pat. No. 4,790,306 to Braun), filtering face-piece respirators are designed to have the filter media cover much of the mask body so that there is no need for installing or replacing a filter cartridge. These filtering face-piece respirators commonly come in one of two configurations: molded respirators and flat-fold respirators.

Molded filtering face-piece respirators often include non-woven webs of thermally-bonded fibers or open-work plastic meshes to furnish the mask body with its cup-shaped configuration. Molded respirators tend to maintain the same shape during both use and storage. These respirators, therefore, cannot be folded flat for storage and shipping. Examples of patents that disclose molded, filtering, face-piece respirators include U.S. Pat. No. 7,131,442 to Kronzer et al; U.S. Pat. Nos. 6,923,182 and 6,041,782 to Angadjivand et al.; U.S. Pat. No. 4,807,619 to Dyrud et al.; and U.S. Pat. No. 4,536,440 to Berg.

Flat-fold respirators, as the name implies, can be folded flat for shipping and storage. Such respirators can be opened into a cup-shaped configuration for use. Examples of flat-fold respirators are described in U.S. Pat. Nos. 6,568,392 and 6,484,722 to Bostock et al.; and U.S. Pat. No. 6,394,090 to Chen. Some flat-fold respirators have been designed with weld lines, seams, and folds to help maintain their cup-shaped configuration during use.

Flat-fold respirators have two general orientations when folded flat for storage. In one configuration—sometimes referred to as a “horizontal” flat-fold respirator—the mask body is folded crosswise such that it has an upper portion and a lower portion. A second type of respirator is referred to as a “vertical” flat-fold respirator because the primary fold is oriented vertically when the respirator is viewed from the front in an upright position. Vertical flat-fold respirators have left and right portions on opposing sides of the vertical fold or a centerline of the mask body.

### SUMMARY

In general, the present disclosure provides various embodiments of a filtering face-piece respirator and method of forming such respirator. The respirator can include a reinforcing element disposed on or within a mask body of the respirator. The reinforcing element can define a reinforced zone of the mask body that is at least partially surrounded by a collapsible zone of the mask body. The collapsible zone can be disposed along at least a portion of a perimeter of the mask body. In one or more embodiments, the reinforcing element can help prevent the reinforced zone from substantially collapsing towards a face of a wearer when the respirator is disposed on the face and in use.

In one aspect, the present disclosure provides a filtering face-piece respirator that includes a mask body. The mask body includes an inner cover web, an outer cover web, and filter media disposed between the inner cover web and the outer cover web in a filter region of the mask body. The mask body further includes right and left portions on each side of a centerline, where the right and left portions are bounded by a perimeter of the mask body; a collapsible zone disposed along at least a portion of the perimeter of the mask body; and a reinforcing element disposed in an upper region of the mask body to define a reinforced zone of the mask body. The reinforced zone is at least partially surrounded by the collapsible zone, where the reinforcing element extends across the centerline between the right and left portions of the mask body, and where the reinforcing element includes a width of at least about 5 mm and no greater than about 50 mm as measured in a direction parallel to the centerline. Further, a distance on the mask body along the centerline between an upper perimeter segment of the perimeter and the reinforcing element is no greater than about 5 mm.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### Glossary

The terms set forth below will have the meanings as defined:

“collapsible zone” means a portion or portions of the mask body disposed between the reinforced zone and the perimeter of the mask body that are adapted to conform to portions of a face of a user;

“contaminants” means particles (including dusts, mists, and fumes) and/or other substances that generally may not be considered to be particles (e.g., organic vapors, etc.) but which may be suspended in air;

“crosswise dimension” is the dimension that extends laterally across the respirator, from side-to-side when the respirator is viewed from the front;

“cup-shaped configuration,” and variations thereof, mean any vessel-type shape that is capable of adequately covering the nose and mouth of a person;

“exterior gas space” means the ambient atmospheric gas space into which exhaled gas enters after passing through and beyond the mask body and/or exhalation valve;

“exterior surface” means the surface of the mask body exposed to ambient atmospheric gas space when the mask body is positioned on the person's face;

“filtering face-piece” means that the mask body itself is designed to filter air that passes through it; there are no separately identifiable filter cartridges or insert-molded filter elements attached to or molded into the mask body to achieve this purpose;

“filter” or “filtration layer” means one or more layers of air-permeable material, which layer(s) is adapted for the primary purpose of removing at least some contaminants (such as particles) from an air stream that passes through it;

“filter media” means an air-permeable structure that is designed to remove at least some contaminants from air that passes through it;

“filtered air” means a volume of atmospheric ambient air that has been filtered to remove at least some contaminants;

“filtering structure” and “breathable filtering structure” each means a generally air-permeable construction that filters air;

“folded inwardly” means being bent back towards the part from which it extends;

“harness” means a structure or combination of parts that assists in supporting the mask body on a wearer's face;

“integral” means being manufactured together; that is, being made together as one part and not two separately manufactured parts that are subsequently joined together;

“interior gas space” means the space between a mask body and a wearer's face;

“interior perimeter” means the outer edge of the mask body, on the interior surface of the mask body, which would be disposed generally in contact with a wearer's face when the respirator is positioned on the wearer's face;

“interior surface” means the surface of the mask body closest to a wearer's face when the mask body is positioned on the wearer's face;

“line of demarcation” means a fold, seam, weld line, bond line, stitch line, hinge line, and/or any combination thereof;

“mask body” means an air-permeable structure that is designed to fit over the nose and mouth of a person and that helps define an interior gas space separated from an exterior gas space (including the seams and bonds that join layers and parts thereof together);

“nose clip” means a mechanical device (other than a nose foam), which device is adapted for use on a mask body to improve the seal around a wearer's nose;

“perimeter” means the outer edge of the mask body, which outer edge would be disposed generally proximate to a wearer's face when the respirator is being donned by a person; a “perimeter segment” is a portion of the perimeter;

“pleat” means a portion of the mask body that is designed to be or is folded back upon itself;

“polymeric” and “plastic” each mean a material that mainly includes one or more polymers and that may contain other ingredients as well;

“reinforced zone” means a portion or portions of the mask body that are formed by one or more of the reinforcing element, one or more cover webs, and one or more lines of demarcation;

“reinforcing element” means an elongate element disposed on or within the mask body that increases the rigidity of at least a portion of the mask body;

“respirator” means an air filtration device that is worn by a person to provide the wearer with filtered air to breathe;

“tab” means a portion of a respirator that extends from the perimeter of the mask body of the respirator and is not a part of the breathable region of the respirator, i.e., in a non-breathable region of the respirator; and

“transversely extending” means extending generally in the crosswise dimension.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic front plan view of one embodiment of a filtering face-piece respirator.

FIG. 2 is a schematic side plan view of the filtering face-piece respirator of FIG. 1.

FIG. 3 is a schematic rear plan view of the filtering face-piece respirator of FIG. 1.

FIG. 4 is a schematic cross-section view of a portion of a mask body of the filtering face-piece respirator of FIG. 1.

FIG. 5 is a schematic view of one embodiment of a method of forming a filtering face-piece respirator.

FIG. 6 is a schematic side plan view of another embodiment of a filtering face-piece respirator.

### DETAILED DESCRIPTION

In general, the present disclosure provides various embodiments of a filtering face-piece respirator and method of forming such respirator. The respirator can include a reinforcing element disposed on or within a mask body of the respirator. The reinforcing element can define a reinforced zone of the mask body that is at least partially surrounded by a collapsible zone of the mask body. The collapsible zone can be disposed along at least a portion of a perimeter of the mask body. In one or more embodiments, the reinforcing element can help prevent the reinforced zone from substantially collapsing towards a face of a wearer when the respirator is disposed on the face and in use.

Flat-fold respirators, which can be folded flat for shipping and storage, can also be opened into a cup-shaped configuration for use. Flat-fold respirators can include weld lines, seams, and folds that are designed to help maintain the respirator in the cup-shaped configuration during use. Some flat-fold respirators, however, tend to collapse when in use due to increased pressure drop across the mask body caused by dirt or moisture that has collected on or within a mask body of the respirator.

One or more embodiments of filtering face-piece respirators described herein can include a reinforcing element disposed in one or more portions of a reinforced zone of a mask body of the respirator. The reinforcing element can help prevent collapse of the mask body of the respirator when the mask body is in an opened cup-shaped configuration. Further, one or more embodiments of a filtering face-piece respirator described herein can maintain an interior gas space of the respirator when the respirator is in the cup-shaped configuration. Such increased interior gas space can reduce a pressure drop across the mask body of the respirator. Further, one or more embodiments of a filtering face-piece respirator described herein can also include a collapsible zone that is disposed along at least a portion of a perimeter of the mask body. Such conformable perimeter can help to provide a seal between the mask body of the respirator and the wearer's face.

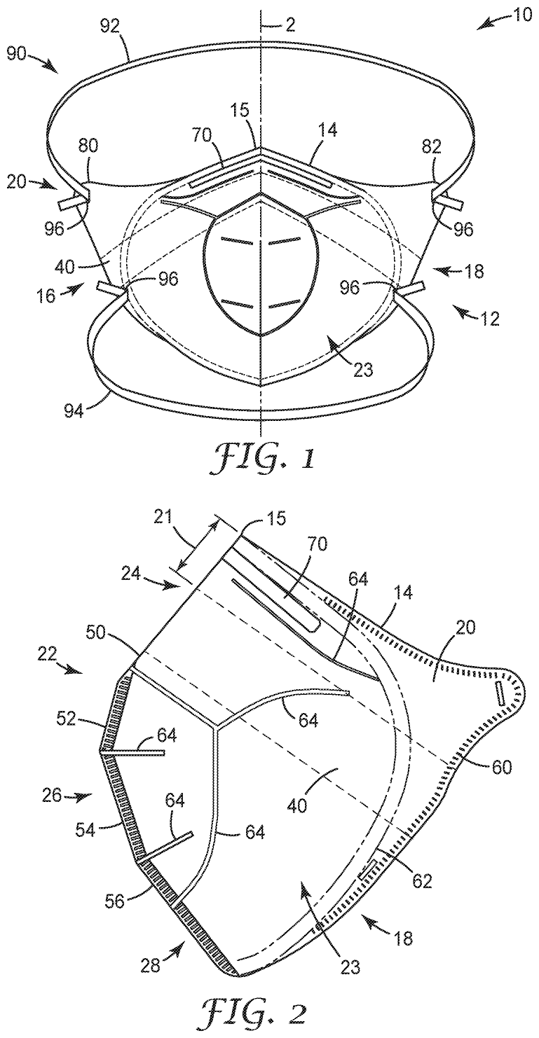

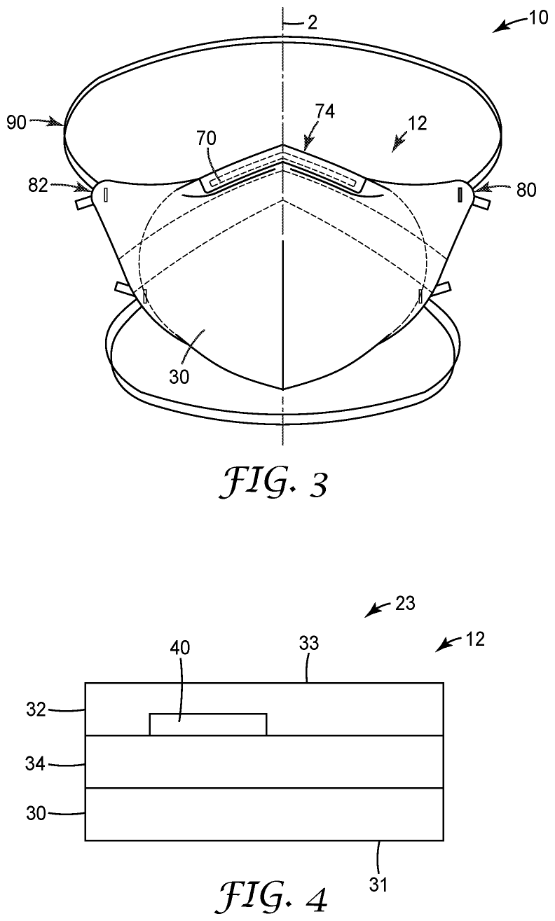

FIGS. 1-4 are various schematic views of one embodiment of a filtering face-piece respirator 10. The filtering face-piece respirator 10 can include any suitable respirator, e.g., a flat-fold filtering face-piece respirator, a molded filtering face-piece respirator, etc. In the illustrated embodiment, the respirator 10 is a flat-fold respirator. The respirator 10 includes a mask body 12. Any suitable material or combination of materials can be included in the mask body 12 as is further described herein.

The mask body 12 includes right and left portions 16 and 18 on each side of a centerline 2. As used herein, the terms “right” and “left” refer to one or more elements or portions of a respirator as viewed from the perspective of a wearer who has donned the respirator. The right and left portions 16, 18 are bounded by a perimeter 14 of the mask body 12. The mask body 12 further includes a collapsible zone 20 disposed along at least a portion of the perimeter 14 of the mask body. In one or more embodiments, the collapsible zone 20 can be disposed along the entire perimeter 14 of the mask body 12. Respirator 10 can include a vertical fold along the centerline 2, thereby providing a vertical fold respirator. In one or more embodiments, the mask body 12 can include a horizontal fold along a horizontal axis that is transverse to the centerline 2 such that the respirator is a horizontal fold respirator.

The mask body 12 further includes a reinforcing element 40 disposed in an upper region 24 of the mask body. As used herein, the term “upper region” refers to one or more regions or portions of the mask body disposed between a central region of the mask body and an upper perimeter segment of a perimeter of the mask body. As illustrated in FIG. 2, the upper region 24 of the mask body 12 is disposed between a central region 26 and the upper perimeter segment 15 of the perimeter 14 of the mask body 12. The reinforcing element 40 defines a reinforced zone 22 of the mask body 12. The reinforced zone 22 is at least partially surrounded by the collapsible zone 20. In one or more embodiments, the reinforced zone 22 can be completely surrounded or circumscribed by the collapsible zone 20. The reinforcing element 40 can extend across the centerline 2 between the right and left portions 16, 18 of the mask body 12.

In general, the mask body 12 can take any suitable shape or combination of shapes and have any suitable dimensions. The mask body 12 can include the upper region 24, the central region 26, and a lower region 28. Such regions can be defined in any suitable manner, e.g., one or more lines of demarcation can be disposed in or formed on the mask body 12 that defines one or more of the upper, central, and lower regions 24, 26, 28 of the mask body 12 as described, e.g., in U.S. Pat. No. 6,394,090 to Chen et al. entitled FLAT-FOLDED PERSONAL RESPIRATORY PROTECTION DEVICES AND PROCESSES FOR PREPARING SAME. The first and second portions can be separated by a first line of demarcation, and the second and third portions can be separated by a second line of demarcation. The one or more lines of demarcation can be substantially continuous, discontinuous, straight, curvilinear, and a combination thereof. Further, the one or more lines of demarcation can be formed using any suitable technique or combination of techniques as is further described herein.

The collapsible zone 20 of the mask body 12 can also be defined, e.g., by one or more lines of demarcation. For example, the mask body 12 can include a first perimeter seal 60 and second perimeter seal 62. As illustrated in FIGS. 1-3, the collapsible zone 20 can be defined by the first perimeter seal 60 and the second perimeter seal 62. Any suitable technique or combination of techniques can be utilized to form the first perimeter seal 60 and the second perimeter seal 62, e.g., ultrasonic welding, thermal bonding, adhesive attachment, mechanical attachment, and combinations thereof. Further, the first perimeter seal 60 and the second perimeter seal 62 can take any suitable shape or combination of shapes. In one or more embodiments, the first perimeter seal 60 at least partially surrounds the collapsible zone 20 and the second perimeter seal 62 at least partially surrounds the reinforced zone 22. Although described as seals, the first perimeter seal 60 and the second perimeter seal 62 can also include any other suitable line of demarcation.

One or both of the first perimeter seal 60 and the second perimeter seal 62 can be adapted to contact a face of a wearer. In one or more embodiments, one or both of the first perimeter seal 60 and the second perimeter seal 62 can be adapted to provide a seal against the face of the wearer. In one or more embodiments, the collapsible zone 20 can defined a face seal that is adapted to at least partially conform to the face of the wearer. Further, in one or more embodiments, a separate seal or gasket can be attached to one or both of the first perimeter seal 60 and second perimeter seal 62 to provide a seal against the face of the wearer.

The mask body 12 can further include one or more additional lines of demarcation 64. Such lines of demarcation 64 can be formed using any suitable technique or combination of techniques and be disposed in any suitable portion or portions of the mask body 12. In one or more embodiments, the additional lines of demarcation 64 can help to maintain the cup-shaped configuration of the mask body 12. Further, in one or more embodiments, the one or more lines of demarcation 64 can secure the reinforcing element 40 to one or more layers of the mask body 12 such the reinforcing element remains in its desired location. The additional lines of demarcation 64 can include any suitable line of demarcation. Further, the one or more additional lines of demarcation 64 can take any suitable shape or combination of shapes and be disposed on or within the mask body 12 in any suitable location and configuration.

The mask body 12 can include any suitable layer or layers. For example, FIG. 4 is a schematic cross-section view of a portion of the mask body 12. The mask body 12 can include an inner cover web 30, outer cover web 32, and filter media 34 disposed between the inner cover web and the outer cover web in a filter region 23 of the mask body. The filter region 23 can be disposed in any suitable location on or within the mask body 12. In one or more embodiments, the filter region 23 is disposed in the reinforced zone 22. In one or more embodiments, the filter region 23 is coextensive with the reinforced zone 22. In one or more embodiments, the filter region 23 has a surface area that is less than a surface area of the reinforced zone 22. In one or more embodiments, the filter region 23 has a surface area that is greater than a surface area of the reinforced zone 22.

In one or more embodiments, two or more of the inner cover web 30, the outer cover web 32, and the filter media 34 can be connected together along the first perimeter seal 60. Further, in one or more embodiments, at least two of the inner cover web 30, outer cover web 32, and filter media 34 can be connected together along the second perimeter seal 62. And in one or more embodiments, at least two of the inner cover web 30, outer cover web 32, and filter media 34 can be connected together along one or more of a first seal region 52, second seal region 54, and third seal region 56 as shown in FIG. 2.

In such embodiments, the mask body 12 can be considered a nose fold mask body with a vertical fold 50 disposed along the centerline 2 in the upper region 24 of the mask body 12, and first, second, and third seal regions 52, 54, 56 in the central and lower regions 26, 28 of the mask body. In one or more embodiments, the mask body 12 can be a center fold mask body with a seal region replacing the vertical fold 50 in the upper region 24 of the mask body, and a vertical fold replacing one or both of the first and second seal regions 52, 54 of the central region 26 of the mask body. Further, in one or more embodiments, the mask body 12 can be a chin fold mask body with the third seal region 56 being replaced by a vertical fold, and the vertical fold 50 in the upper region 24 of the mask body being replaced with a seal region.

As illustrated in FIG. 4, the mask body 12 also includes the reinforcing element 40. The reinforcing element 40 can be disposed in any suitable location on or within the mask body 12. In the embodiment illustrated in FIGS. 1-4, the reinforcing element 40 is disposed between the outer cover web 32 and the filter media 34. In one or more embodiments, the reinforcing element 40 can be disposed between the inner cover web 30 and the filter media 34, on an outer surface 33 of the outer cover web 32, or on an outer surface 31 of the inner cover web.

As illustrated, the reinforcing element 40 is disposed in the reinforced zone 22 in the upper region 24 of the mask body 12. In one or more embodiments, the reinforcing element 40 is disposed only in the upper region 24 of the mask body 12 such that it does not extend into the central region 26 or the lower region 28. In one or more embodiments, at least a portion of the reinforcing element 40 can extend into one or both of the central region 26 and lower region 28 of the mask body 12. In embodiments where the respirator 10 is a vertical fold respirator having a vertical fold 50, the reinforcing element 40 can extend through the vertical fold between the right portion 16 and the left portion 18 of the mask body 12. The reinforcing element 40 can extend between the perimeter 14 and the right portion 16 of the mask body 12 and the perimeter in the left portion 18 of the mask body. In one or more embodiments, the reinforcing element 40 extends between the second perimeter seal 62 in the right portion 16 of the mask body 12 and the second perimeter seal in the left portion 18 of the mask body 12. Further, the reinforcing element 40 does not extend into the collapsible zone 20.

In one or more embodiments, the reinforcing element 40 can be disposed in two or more regions of the mask body. For example, the reinforcing element 40 can be disposed in at least a portion of the upper region 24, the central region 26, and the lower region 28. Further, in one or more embodiments, the respirator 10 can include two or more reinforcing elements that are disposed in any suitable locations on or within the mask body 12.

The reinforcing element 40 can take any suitable shape or combination of shapes and include any suitable dimensions. In one or more embodiments, the reinforcing element 40 includes a width of at least about 5 mm, at least about 10 mm, at least about 15 mm, at least about 20 mm as measured in a direction parallel to the centerline 2. In one or more embodiments, the reinforcing element 40 includes a width that is no greater than about 50 mm, no greater than about 45 mm, no greater than about 40 mm, no greater than about 35 mm, no greater than about 30 mm. Further, the reinforcing element 40 can have any suitable thickness or average thickness. In one or more embodiments, the reinforcing element 40 can have a thickness that is at least about 0.1 mm. In one or more embodiments, the reinforcing element 40 can have a thickness that is no greater than about 5 mm. Further, the reinforcing element 40 can have any suitable length as measured in a direction orthogonal to the centerline 2 when the mask body 12 is in a flat configuration. In one or more embodiments, the reinforcing element 40 can have a length that is at least about 5 mm. Further, in one or more embodiments, the reinforcing element 40 can have a length that is no greater than 350 mm.

The reinforcing element 40 can be disposed in any suitable location on or within the mask body 12. For example, the reinforcing element 40 can be disposed any suitable distance as measured along the mask body 12 and along the centerline 2 between the upper perimeter segment 15 of the perimeter 14 and the reinforcing element. In one or more embodiments, a distance 21 (FIG. 2) on the mask body 12 along the centerline 2 between the upper perimeter segment 15 and the reinforcing element 40 is no greater than 10 mm, no greater than 8 mm, no greater than 5 mm, no greater than 3 mm, no greater than 1 mm.

In one or more embodiments, the reinforcing element 40 can be fixed in place by one or more weld lines formed in the mask body. For example, one or more of the additional lines of demarcation 64 can be disposed such that they hold the reinforcing element 40 in place to help prevent the element from shifting or moving relative to the layers of the mask body 12. Further, in one or more embodiments, the reinforcing element 40 can be welded to one or more layers of the mask body 12 by a weld line or seal. For example, the reinforcing element 40 can be attached to the outer cover web 32 by one or more weld lines formed between the outer cover web and the reinforcing element 40. In one or more embodiments, the reinforcing element 40 is not connected or attached to one or more layers of the mask body 12 but is instead held in place by being compressed between the second perimeter seal 62 in the right portion 16 and the left portion 18 of the mask body 12.

The reinforcing element 40 can include any suitable material or combination of materials. In one or more embodiments, the reinforcing element 40 can include one or more of a metallic, polymeric, fibrous, inorganic fibrous, or ceramic material. In one or more embodiments, the reinforcing element 40 can include a non-woven material, e.g., the same non-woven material described regarding filter media 34. The reinforcing element 40 can be a continuous layer or layers. In one or more embodiments, the reinforcing element 40 can be a discontinuous layer or layers having one or more perforations or openings formed through the reinforcing element, e.g., a netting or mesh. Further, the reinforcing element 40 can include any suitable number of layers each having the same or different materials.

The reinforcing element 40 can have any suitable basis weight. In one or more embodiments, the reinforcing element 40 has a basis weight of at least about 50 grams per square meter (gsm), at least about 60 gsm, at least about 70 gsm, at least about 80 gsm, at least about 90 gsm, at least about 100 gsm. In one or more embodiments, the reinforcing element 40 can have a basis weight that is no greater than about 200 gsm, about 190 gsm, about 180 gsm, about 170 gsm, about 160 gsm, about 150 gsm.

Further, the reinforcing element 40 can have any suitable value of bending resistance as determined utilizing the T 543 om-11 (2011) test method with a 50 gsm support layer. For example, in one or more embodiments, the reinforcing element 40 can have a machine direction bending resistance of at least about 1 milligrams of force (mgf). In one or more embodiments, the reinforcing element 40 can have a cross direction bending resistance of at least about 1 mgf. Further, in one or more embodiments, the reinforcing element 40 can have a machine direction bending resistance of no greater than about 10 mgf. In one or more embodiments, the reinforcing element 40 can have a cross direction bending resistance of no greater than about 10 mgf.

The reinforcing element 40 can provide the reinforced zone 22 of the mask body 12 with a bending force that is greater than a bending force of the collapsible zone 20. In one or more embodiments of respirators described herein, a reinforced zone having a greater bending force than that of the collapsible zone provides a respirator body that may retain its cup-shaped configuration and, therefore, maintain the interior gas space of the mask body when the wearer is utilizing the respirator. Further, such difference in bending force can provide a collapsible zone that better conforms to the face of the user to provide a more effective seal between the respirator and the wearer's face.

The collapsible zone 20 can have any suitable bending force. Further, the reinforced zone 22 can have any suitable bending force. In one or more embodiments, the bending force of the collapsible zone 20 is less than the bending force of the reinforced zone 22 of the mask body 12. In one or more embodiments, the bending force of the collapsible zone 20 is no greater than 90%, 80%, 70%, 60%, or 50% of the bending force of the reinforced zone 22. The bending force of the collapsible zone 20 and the reinforcing zone 22 can be determined using any suitable technique or combination of techniques.

In one or more embodiments, the reinforcing element 40 can be air permeable as determined utilizing the ASTM D737-04 (2016) test method with a 1 inch diameter test opening, an 8 mm orifice, and 1/100 inches of water pressure. In one or more embodiments, the reinforcing element 40 can have an air permeability of at least about 500 ft³/min/ft². In one or more embodiments, the reinforcing element 40 can have an air permeability of no greater than about 1200 ft³/min/ft².

In one or more embodiments, a respirator that includes a reinforcing element as described herein can have a pressure drop that is comparable to a pressure drop of a similar respirator that does not include the reinforcing element. In one or more embodiments, a pressure drop of the filtering face-piece respirator 10 that includes the reinforcing element 40 is no greater than 5%, 4%, 3%, 2%, or 1% of a pressure drop of the filtering face-piece respirator that does not include the reinforcing element. Any suitable technique or combination of techniques can be utilized to determine the pressure drop of respirator 10 with and without the reinforcing element 40. In one or more embodiments, the pressure drop can be determined utilizing a silicon dummy head that is connected to an air pump cylinder to simulate human breathing. A pressure drop sensor can be disposed between the silicon dummy head and a respirator disposed over a mouth of the head.

In general, the filter region 23 removes at least some contaminants from the ambient air and may also act as a barrier layer that precludes liquid splashes from entering the mask interior. The outer cover web 32 can act to stop or slow any liquid splashes, and the filter media 34 may then contain them if there is penetration past the other layers. The filter region 23 of the mask body 12 can include a particle capture or gas and vapor type filter. The filter region 23 may include multiple layers of similar or dissimilar filter media and one or more cover webs as the application requires. In one or more embodiments, the respirator 10 can contain a fluid impermeable mask body that has one or more filter cartridges attached to it. See, e.g., U.S. Pat. No. 6,874,499 to Viner et al.; U.S. Pat. Nos. 6,277,178 and D613,850 to Holmquist-Brown et al.; RE39,493 to Yuschak et al.; D652,507, D471,627, and D467,656 to Mittelstadt et al.; and D518,571 to Martin.

The inner and outer cover webs 30, 32 may be located on the outer sides of the filtering region 23 to capture any fibers that could come loose therefrom. Typically, the cover webs 30, 32 are made from a selection of fibers that provide a comfortable feel, particularly on outer surface 31 of the inner cover web 30 that makes contact with the wearer's face. The constructions of various filter layers, shaping layers, and cover webs that may be used with the mask body 12 are described herein in more detail.

The filter media 34 can include any filter media that may be beneficially employed in the respirator 10 and generally low in pressure drop (e.g., less than about 195 to 295 Pascals at a face velocity of 13.8 centimeters per second) to minimize the breathing work of the mask wearer. Filter media can also be flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged can provide utility for particulate capture applications.

In one or more embodiments, the filter media 34 can include one or more filtration layers. Any suitable filtration layer or layers can be included in filter media 34. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area. See, e.g., U.S. Pat. Nos. 5,804,295 and 5,656,368 to Braun et al. The media 34 also may include multiple filtration layers.

Essentially any suitable material that is known (or later developed) for forming a filtration layer may be used as the filter media 34. In one or more embodiments, webs of melt-blown fibers, such as those taught in Wente, Van A., Superfine Thermoplastic Fibers, 48 Indus. Eng. Chem., 1342 et seq. (1956), especially when in a persistent electrically charged (electret) form can be utilized (see, e.g., U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. In one or more embodiments, the filtration layer can include one or more BMF webs that contain fibers formed from polypropylene, poly(4-methyl-1-pentene), and combinations thereof. Electrically charged fibrillated-film fibers as taught in U.S. Pat. Re. 31,285 to van Turnhout also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al.; U.S. Pat. No. 6,783,574 to Angadjivand et al.; U.S. Pat. No. 6,743,464 to Insley et al.; U.S. Pat. Nos. 6,454,986 and 6,406,657 to Eitzman et al.; and U.S. Pat. Nos. 6,375,886 and 5,496,507 to Angadjivand et al. Electric charge also may be imparted to the fibers by corona charging as disclosed in U.S. Pat. No. 4,588,537 to Klasse et al., or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment. See, e.g., U.S. Pat. Nos. 6,398,847, 6,397,458, and 6,409,806 to Jones et al. Typical basis weights for electret BMF filtration layers are about 10 to 100 gsm. When electrically charged according to techniques described in, e.g., the '507 Angadjivand et al. Patent, and when including fluorine atoms as mentioned in the Jones et al. Patents, the basis weight may be about 20 to 40 gsm and about 10 to 30 gsm, respectively.

In one or more embodiments, the filter media 34 can include a layer that includes sorptive materials such as activated carbon that can be disposed between the fibers and/or various layers that include the filtering structure. Further, separate particulate filtration layers may be used in conjunction with sorptive layers to provide filtration for both particulates and vapors. The sorbent component may be used for removing hazardous or odorous gases from the breathing air. Sorbents may include powders or granules that are bound in a filter layer by adhesives, binders, or fibrous structures. See, e.g., U.S. Pat. No. 6,234,171 to Springett et al. and U.S. Pat. No. 3,971,373 to Braun.

For example, a variety of particles can be employed as sorbents. In one or more embodiments, the particles are capable of absorbing or adsorbing gases, aerosols or liquids expected to be present under the intended service conditions. The particles can be in any useful form, including beads, flakes, granules, fibers, or agglomerates. Exemplary particles include activated carbon, alumina and other metal oxides, clay, hopcalite and other catalysts, ion exchange resins, molecular sieves and other zeolites, silica, sodium bicarbonate, biocides, fungicides and virucides. Mixtures of particles can be employed, e.g., to absorb mixtures of gases.

A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtering structure that may be conformed into various configurations is described in U.S. Pat. No. 6,391,429 to Senkus et al.

The cover webs 30, 32 may also have filtering abilities. One or both of the cover webs 30, 32 may also serve to make the respirator 10 more comfortable to wear. The cover webs may be made from nonwoven fibrous materials such as spun bonded fibers that contain, e.g., polyolefins, and polyesters. See, e.g., U.S. Pat. No. 6,041,782 to Angadjivand et al.; U.S. Pat. No. 4,807,619 to Dyrud et al.; and U.S. Pat. No. 4,536,440 to Berg. When a wearer inhales, air is drawn through the mask body, and airborne particles become trapped in the interstices between the fibers, particularly the fibers in the filter layer.

The inner cover web 30 can be used to provide a smooth surface for contacting the wearer's face. Further, the outer cover web 32, in addition to providing splash fluid protection, can be used for entrapping loose fibers in the mask body and for aesthetic reasons. The outer cover web 32 typically does not provide any substantial filtering benefits to the mask body 12, although it can act as a pre-filter when disposed on the exterior of (or upstream to) the filter media 34. To obtain a suitable degree of comfort, the inner cover web 30 can have a comparatively low basis weight and can be formed from comparatively fine fibers. In one or more embodiments, the inner cover web 30 may be fashioned to have a basis weight of about 5 to 70 gsm (typically 10 to 30 gsm), and the fibers may be less than 3.5 denier (typically less than 2 denier, and more typically less than 1 denier but greater than 0.1 denier). Fibers used in the cover webs 30, 32 often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover webs 30, 32 may be blown microfiber (BMF) materials, e.g., polyolefin BMF materials, e.g., polypropylene BMF materials (including polypropylene blends and also blends of polypropylene and polyethylene). And an exemplary process for producing BMF materials for a cover web is described in U.S. Pat. No. 4,013,816 to Sabee et al. The web may be formed by collecting the fibers on a smooth surface, typically a smooth-surfaced drum or a rotating collector. See, e.g., U.S. Pat. No. 6,492,286 to Berrigan et al. Spun-bond fibers may also be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 gsm and having a fiber denier in the range 0.2 to 3.1 (with an average, measured over 100 fibers of about 0.8). Another suitable fiber is a polypropylene/polyethylene BMF (produced from a mixture comprising 85% of the resin “Escorene 3505G” and 15 percent of the ethylene/alpha-olefin copolymer “Exact 4023” also from Exxon Corporation) providing a basis weight of about 25 gsm and having an average fiber denier of about 0.8. Suitable spunbond materials are available under the trade designations “Corosoft Plus 20,” “Corosoft Classic 20” and “Corovin PP S 14,” from Corovin GmbH of Peine, Germany, and a carded polypropylene/viscose material available, under the trade designation “370/15,” from J.W. Suominen OY of Nakila, Finland. Cover webs typically have very few fibers protruding from the web surface after processing and therefore have a smooth outer surface. Examples of cover webs that may be used in a respirator of the present disclosure are described, e.g., in U.S. Pat. No. 6,041,782 to Angadjivand; U.S. Pat. No. 6,123,077 to Bostock et al.; and PCT Publication No. WO 96/28216A to Bostock et al.

In one or more embodiments, one or both of the inner cover web 30 and outer cover web 32 can include a polymeric netting. Any suitable polymeric netting can be utilized for one or both cover webs. The netting may be made from a variety of polymeric materials. Polymers suitable for netting formation are thermoplastic materials. Examples of thermoplastic polymers that can be used to form polymer netting of the present invention include polyolefins (e.g., polypropylene and polyethylene), polyethylene-vinyl acetate (EVA), polyvinyl chloride, polystyrene, nylons, polyesters (e.g., polyethylene terephthalate), and elastomeric polymers, (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Blends of two or more materials also may be used in the manufacture of nettings. Examples of such blends include polypropylene/EVA and polyethylene/EVA. Polypropylene may be preferred for use in the polymeric netting since melt-blown fibers are regularly made from polypropylene. Use of similar polymers enables proper welding of the support structure to the filtering structure.

The respirator 10 can also include a right tab 80 that extends from the right portion 16 of the mask body and a left tab 82 that extends from the left portion 18 of the mask body. In one or more embodiments, one or both of the right tab 80 and left tab 82 can be integral with the mask body 12. In one or more embodiments, one or both of the left and right tabs 80, 82 can be separately manufactured and then connected to the mask body 12 at the perimeter 14 using any suitable technique or combination of techniques. In one or more embodiments, the right and left tabs 80, 82 are disposed in the collapsible zone 20 of the mask body 12, i.e., the right and left tabs form a part of the collapsible zone 20.

The right and left tabs 80, 82 can take any suitable shape or combination of shapes and have any suitable dimensions. Exemplary right and left tabs are described, e.g., in PCT Publication Nos. WO2016058165 and WO2016058163 to Chen et al. The right and left tabs 80, 82 of the present disclosure can also include additional features. For example, in one or more embodiments, one or both of the right and left tabs 80, 82 can include welds or bonds (not shown) provided thereon. In one or more embodiments, these welds or bonds can provide any suitable functionality to the right and left tabs 80, 82. For example, in one or more embodiments, the welds or bonds can increase a stiffness of one or both of the right and left tabs 80, 82. Any suitable technique or combination of techniques can be utilized to form these welds.

The respirator 10 can also include a harness 90. The harness 90 can include any suitable harness. In the embodiment illustrated in FIGS. 1-3, the harness 90 includes an upper strap 92 and a lower strap 94 that are connected to the mask body 12 at attachment points 96. The attachment points 96 can be disposed in a suitable location on the mask body 12. In one or more embodiments, one or more attachment points 96 can be disposed on one or both of the right tab 80 and left tab 82. Each of the upper strap 92 and the lower strap 94 can have any suitable length. In one or more embodiments, a length of one or both of the upper strap 92 and lower strap 94 can be no greater than about two times a distance from one of its attachment points 96 to the centerline 2 as measured in a direction orthogonal to the centerline when the respirator 10 is in a flat configuration as is further described, e.g., in PCT Patent Publication No. WO2016058163.

In general, the strap(s) that are used in the respirator harness can be expanded to greater than twice its total length and can be returned to its relaxed state many times throughout the useful life of the respirator. The strap also could possibly be increased to three or four times its relaxed state length and can be returned to its original condition without any damage thereto when the tensile forces are removed. In one or more embodiments, the elastic limit thus is not less than two, three, or four times the relaxed-state length of the strap(s). Typically, the strap(s) are about 20 to 32 cm long, 3 to 20 mm wide, and about 0.3 to 1 mm thick. The strap(s) may extend from the first side of the respirator to the second side as a continuous strap, or the strap may have a plurality of parts, which can be joined together by further fasteners or buckles. For example, the strap may have first and second parts that are joined together by a fastener that can be quickly uncoupled by the wearer when removing the mask body from the face. In one or more embodiments, the strap may form a loop that is placed around the wearer's ears. See, e.g., U.S. Pat. No. 6,394,090 to Chen et al. Examples of fastening or clasping mechanisms that may be used to join one or more parts of the strap together are shown, e.g., in U.S. Pat. No. 6,062,221 to Brostrom et al. and U.S. Pat. No. 5,237,986 to Seppala et al.; and in EP Patent Publication No. 1,495,785A1 to Chien. The harness may also include a reusable carriage, one or more buckles, and/or a crown member to support the respirator on a person's head. See, e.g., U.S. Pat. Nos. 6,732,733 and 6,457,473 to Brostrom et al.; and U.S. Pat. Nos. 6,591,837 and 6,715,490 to Byram.

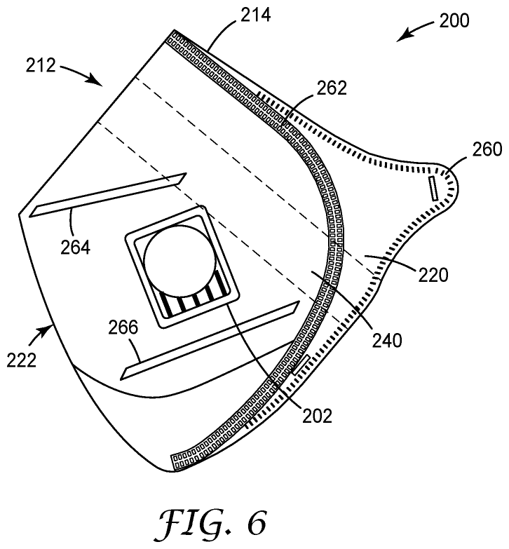

In one or more embodiments, an exhalation valve (not shown) may be attached to the mask body 12 to facilitate purging exhaled air from the interior gas space (e.g., exhalation valve 202 of FIG. 6). The use of an exhalation valve may improve wearer comfort by rapidly removing the warm moist exhaled air from the mask interior. See, e.g., U.S. Pat. Nos. 7,188,622; 7,028,689, and 7,013,895 to Martin et al.; U.S. Pat. Nos. 7,428,903; 7,311,104; 7,117,868; 6,854,463; 6,843,248; and 5,325,892 to Japuntich et al.; U.S. Pat. Nos. 7,302,951 and 6,883,518 to Mittelstadt et al.; and RE 37,974 to Bowers. Essentially any exhalation valve that provides a suitable pressure drop and that can be properly secured to the mask body 12 may be used in connection with the present disclosure to rapidly deliver exhaled air from the interior gas space to the exterior gas space.

Further, in one or more embodiments, the mask body 12 can include a nose clip 70. Any suitable nose clip 70 can be utilized. In one or more embodiments, the nose clip 70 may be essentially any additional part that assists in improving the fit over the wearer's nose. Because the wearer's face exhibits a major change in contour in the nose region, a nose clip may be used to better assist in achieving the appropriate fit in this location. The nose clip may include, for example, a pliable dead soft band of metal such as aluminum, which can be shaped to hold the mask in a desired fitting relationship over the nose of the wearer and where the nose meets the cheek. The nose clip may be linear in shape when viewed from a plane projected onto the mask body when in its folded or partially folded condition. In one or more embodiments, the nose clip can be an M-shaped nose clip, an example of which is shown in U.S. Pat. Nos. 5,558,089 and Des. 412,573 to Castiglione. Other exemplary nose clips are described in U.S. Pat. No. 8,066,006 to Daugaard et al.; U.S. Pat. No. 8,171,933 to Xue et al.; and U.S. Patent Publication No. 2007-0068529A1 to Kalatoor et al.

The nose clip 70 can be disposed adjacent the upper perimeter segment 15 of the mask body 12. In one or more embodiments, the nose clip 70 is disposed at least partially within the collapsible zone 20 of the mask body 20. The nose clip 70 can be disposed on an outer most surface (i.e., exterior surface 33 of outer cover web 32) of the mask body 12. The nose clip 70 can be disposed on the outermost surface using any suitable technique or combination of techniques. For example, the nose clip 70 can be attached to the outermost surface using, e.g., adhesives, etc. In one or more embodiments, the nose clip 70 can be disposed between the outer cover web 32 and an interior layer, e.g., the filter media 34. The nose clip 70 can be disposed between the outer cover web 32 and the filter media 34 using any suitable technique or combination of techniques, e.g., welding the outer cover web to the filtration layer in a pattern adjacent the nose clip such that the nose clip is secured in place between the outer cover web and the filter media.

Further, in one or more embodiments, a portion (not shown) of the mask body 12 can be folded over upon itself in a nose region of the mask body to form a fold that intersects the centerline 2. The portion of the mask body 12 that is folded over can be attached to and interior surface (e.g., outer surface 31 of the inner cover web 30) of the mask body 12. In one or more embodiments, this portion of the mask body 12 can be folded over onto an exterior surface of the mask body 12. The portion of the mask body 12 that is folded over can be attached to the mask body using any suitable technique or combination of techniques, e.g., welding, adhering, fastening, etc. For example, an edge of the folded portion can be attached to the mask body 12, e.g., by welding the edge to the mask body. In one or more embodiments, the folded-over portion can provide a cushion between the nose clip 70 and the wearer's face as is described, e.g., in U.S. Patent Publication No. 2011/0315144 to Eitzman et al. The folded portion can be used instead of or in addition to a nose foam and can provide additional comfort to a wearer while providing a snug fit over the nose.

As described herein, the respirator 10 can include any suitable lines of demarcation disposed in any suitable location or locations on the mask body 12. For example, FIG. 6 is a schematic plan view of another embodiment of a respirator 200. All of the design considerations and possibilities regarding the respirator 10 of FIGS. 1-4 apply equally to the respirator 200 of FIG. 6. The respirator 200 is shown without a harness for clarity.

The respirator 200 includes a mask body 212 having a perimeter 214. The respirator 200 also includes a collapsible zone 220 disposed along at least a portion of the perimeter 214 of the mask body 212, and a reinforcing element 240 disposed in an upper region of the mask body to define a reinforced zone 222 of the mask body. The reinforced zone 222 is at least partially surrounded by the collapsible zone 220. The respirator 200 also includes a first perimeter seal 260 and a second perimeter seal 262. Disposed in the reinforced zone 222 is a first line of demarcation 264 and a second line of demarcation 266. The respirator 200 can include any suitable number of lines of demarcation, e.g., two or more lines of demarcation. The first and second lines of demarcation 264, 266 can take any suitable shape or combination of shapes and have any suitable dimensions. Although shown on a left portion of the mask body 212, one or more lines of demarcation can be disposed on or in one or both of the left portion and a right portion of the mask body. Further, the first and second lines of demarcation 264, 266 can be disposed in any suitable location or locations in the reinforced zone 222 of the mask body 212.

The respirator 200 also includes an exhalation valve 202 disposed in any suitable location on the mask body 212. The exhalation valve 202 can include any suitable valve, e.g., one or more of the exhalation valves described herein.

The various embodiments of respirators described herein can be manufactured using any suitable technique or combination of techniques. See, e.g., U.S. Pat. No. 6,148, 817 to Bryant et al.; U.S. Pat. No. 6,722,366 to Bostock et al.; U.S. Pat. No. 6,394,090 to Chen et al.; and U.S. Patent Publication No. 2008/0011303 to Angadjivand et al. In general, a flat-folded respirator, e.g., respirator 10 of FIGS. 1-4, can be formed from a single piece, although multiple pieces can be attached to one another using the various techniques described herein, such as a batch process (e.g., by plunge welding) or a continuous process (e.g., rotary welding). In either process, a flat-folded respirator can be manufactured by forming a substantially flat sheet of a multilayer construction (also referred to herein as a “mask body blank”) by bonding and cutting the outer forming edges. Other techniques may be employed for forming the edges, such as ultrasonic welding, stitching, and the application of pressure to form the edges (with or without the addition of heat).

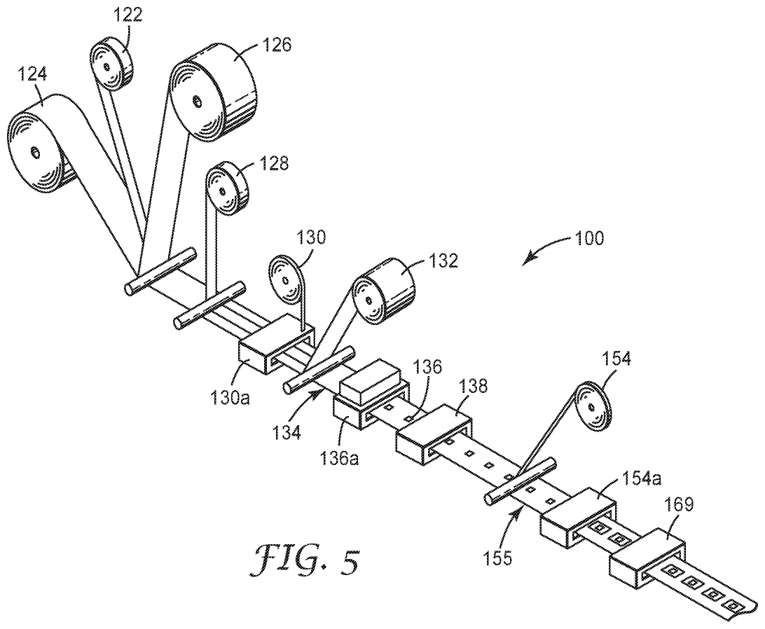

FIG. 5 illustrates one embodiment of a process 100 for manufacturing filtering face-piece respirator 10 of FIGS. 1-4. In one or more embodiments, the process 100 can be continuous, i.e., the respirator 10 can be manufactured along a manufacturing line without the need to remove the respirator from the line prior to completion of the process. Although the process 100 is described in reference to respirator 10 of FIGS. 1-4, the process can be utilized to manufacture any suitable respirator. A foam portion 122 is optionally positioned between the inner cover web 30 and the filtration layer 34. In one or more embodiments, the foam portion 122 and/or nose clip 70 may be positioned on the outer surface 31 of the inner cover web 30 or the outer surface 33 of the outer cover web 32.

The reinforcing element 40 is disposed in the upper region 24 of the mask body 12 on, e.g., the filter media 34 from roll 128. The nose clip 70 is optionally positioned along one edge of the filter media 34 proximate the reinforcing element 40 at a nose clip application station 130a. In one or more embodiments, the nose clip 70 is disposed between the outer cover web 32 and the filter media 34 adjacent the upper perimeter segment 15 as is further described herein. The filtration layer 34, reinforcing element 40, and nose clip 70 are covered by the outer cover web 32 to form a web assembly 134. The web assembly 134 may be held together, e.g., by surface forces, electrostatic forces, thermal bonding, or an adhesive.

An exhalation valve 136 is optionally inserted into the web assembly 134 at a valving station 136a. The valving station 136a can form a hole proximate the center of the web assembly 134. The edges of the hole may be sealed to minimize excess web material. The valve 136 may be retained in the hole, e.g., by welding, adhesive, pressure fit, clamping, snap assemblies or some other suitable means.

The web assembly 134 is welded and, in one or more embodiments, can be trimmed along a perimeter (e.g., perimeter 14 of respirator 10) at face fit station 138. Other lines of demarcation, e.g., welds or bond lines, can be formed at station 138, e.g., first perimeter seal 60, second perimeter seal 62, additional lines of demarcation 64, etc. Any suitable technique or combination of techniques can be utilized to form these and other lines of demarcation on the mask body 12.

The excess web material is removed to form one or more mask body blanks 155. Mask body blanks 155 can include any suitable mask body blank that can be utilized to form respirator 10 of FIGS. 1-4.

At station 154a, strap material 154 forming the upper and lower straps 92, 94 is positioned on the mask body blank 155 and is attached to the mask body blank at attachment points 96. The upper and lower straps 92, 94 can be formed either before or after any excess web material is removed to form one or more mask body blanks 155.

At folding station 169, the blanks 155 are folded along centerline 2 (as shown in FIG. 1), and the central and lower regions 26, 28 are connected by welding the blank together to form seal regions 52, 54, 56. Further, any additional excess web material can be removed from the blanks 155 following folding and sealing at folding station 169.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. A filtering face-piece respirator comprising a mask body, wherein the mask body comprises:
an inner cover web;
an outer cover web;
filter media disposed between the inner cover web and the outer cover web in a filter region of the mask body;
right and left portions on each side of a centerline, wherein the right and left portions are bounded by a perimeter of the mask body;
a collapsible zone disposed along at least a portion of the perimeter of the mask body; and
a reinforcing element disposed in an upper region of the mask body to define a reinforced zone of the mask body, wherein the reinforced zone is at least partially surrounded by the collapsible zone, wherein the reinforcing element extends across the centerline between the right and left portions of the mask body, wherein the reinforcing element comprises a width of at least about 5 mm and no greater than about 50 mm as measured in a direction parallel to the centerline, and further wherein a distance on the mask body along the centerline between an upper perimeter segment of the perimeter and the reinforcing element is no greater than about 5 mm.

2. The respirator of claim 1, wherein the reinforcing element comprises a basis weight of at least about 50 gsm and no greater than about 200 gsm.

3. The respirator of claim 2, wherein the reinforcing element comprises a basis weight of at least about 100 gsm and no greater than about 150 gsm.

4. The respirator of claim 1, wherein a bending force of the collapsible zone of the mask body is less than a bending force of the reinforced zone of the mask body.

5. The respirator of claim 4, wherein the bending force of the collapsible zone is no greater than 90% of the bending force of the reinforced zone.

6. The respirator of claim 1, wherein a pressure drop of the filtering face-piece respirator that includes the reinforcing element is no greater than 3% of a pressure drop of the filtering face-piece respirator that does not include the reinforcing element.

7. The respirator claim 1, wherein the reinforcing element comprises a non-woven material.

8. The respirator of claim 1, wherein the reinforcing element comprises a mesh.

9. The respirator of claim 1, wherein the mask body further comprises a vertical fold along the centerline in the upper portion of the mask body, wherein the reinforcing element extends through the vertical fold.

10. The respirator of claim 9, wherein the mask body further comprises a seal that extends along the centerline between the vertical fold and a bottom perimeter segment of the mask body, wherein the seal connects central and lower regions of each of the right and left portions together.

11. The respirator of claim 9, wherein the reinforcing element does not extend into the central and lower regions of the right and left portions of the mask body.

12. The respirator of claim 1, wherein the reinforcing element extends between the perimeter in the right portion of the mask body and the perimeter in the left portion of the mask body.

13. The respirator of claim 1, further comprising a right tab extending from the right portion of the mask body and a left tab extending from the left portion of the mask body, wherein the right and left tabs are disposed in the collapsible zone.

14. The respirator of claim 1, wherein the collapsible zone of the mask body defines a face seal that is adapted to at least partially conform to a face of a wearer.

15. The respirator of claim 1, wherein the reinforcing element is connected to at least one of the inner and outer cover webs by a weld line.

16. The respirator of claim 1, wherein the reinforcing element does not extend into the collapsible zone.

17. The respirator of claim 1, wherein the reinforcing element comprises an air permeability of at least about 500 cfm/ft² and no greater than about 1200 cfm/ft² as determined utilizing ASTM D737-04 (2016) with a 1 inch diameter test opening, an 8 mm orifice, and 1/100 inches of water pressure.

18. The respirator of claim 1, wherein the reinforcing element comprises a bending resistance of at least about 1 mgf and not greater than about 10 mgf as determined utilizing T 543 om-11 (2011) with a 50 gsm support layer.
